(19) United States
(12) Patent Application Publication
(10) Pub. No.: US 2016/0167174 A1
(43) Pub. Date: Jun. 16, 2016

(54) METHOD FOR LASER BORING OR LASER CUTTING A WORKPIECE

(71) Applicants: ROBERT BOSCH GMBH, Stuttgart (DE); LASER ZENTRUM HANNOVER E.V., Hannover (DE)

(72) Inventors: Claudia UNGER, Hannover (DE); Laszlo SAJTI, Hannover (DE); Juergen KOCH, Hannover (DE); Thorsten BAUER, Memmelsdorf (DE)

(21) Appl. No.: 14/899,861

(22) PCT Filed: Jun. 30, 2014
(86) PCT No.: PCT/EP2014/001778

§ 371 Date: Feb. 12, 2016

(30) Foreign Application Priority Data
Jun. 28, 2013 (DE) 10 2013 212 665.4

(51) Int. Cl. B23K 26/382; B23K 26/18

(52) U.S. Cl. CPC B23K 26/382; B23K 26/18; B23K 2201/001

(57) ABSTRACT

The invention relates to a method for laser boring or laser cutting a workpiece (2), wherein—electromagnetic radiation (10) emitted from a laser strikes the workpiece (2) and—a liquid (16) which contains nanoparticles (18) is located on a workpiece (2) face facing away from the laser such that—the electromagnetic radiation (10) emitted by the laser strikes the nanoparticles (18) when the electromagnetic radiation (10) has passed through the workpiece (2). The nanoparticles are designed such that the majority of the electromagnetic radiation (10) is absorbed by the nanoparticles (18) in that the electromagnetic radiation (10) generates collective excitations, in particular plasmons such as surface plasmons for example, in the nanoparticles (18).

The invention relates to a method for laser drilling or laser cutting a workpiece, wherein electromagnetic radiation emitted by a laser impinges on the workpiece and a liquid containing nanoparticles is situated on a side of the workpiece facing away from the laser such that the electromagnetic radiation emitted by the laser impinges on the nanoparticles once the electromagnetic radiation has passed through the workpiece.

Pulsed lasers with a high pulse energy are required for producing bores with a high aspect ratio and good edge quality by means of a laser within an economic process time. After the electromagnetic radiation emitted by these pulsed lasers has passed through the workpiece, it is a danger to further materials and/or persons situated in the beam path. Particularly in the case where further material is situated at only a small distance opposite the bore emergence side, said material is generally damaged by the emerging laser radiation. The drilling or cutting process cannot be aborted before the damage occurs because the through-hole in the workpiece still needs to be brought into the required shape after opening. The damages that occur are not acceptable for many applications, such as the laser drilling of injection nozzles or the generation of cooling bores in turbine blades. This problem may even occur when cutting raw materials with a small internal diameter, for example when producing medical stents.

The prior art has disclosed different procedures for protecting the material lying behind the bore or cut hole. What is common to all of these is that a material is arranged behind the workpiece in the beam direction of the electromagnetic radiation in order to prevent the electromagnetic radiation from causing damage. In principle, solids, circulating liquids and fluids or particle suspensions come into question in this case.

By way of example, U.S. Pat. No. 6,303,901 B1 has disclosed the practice of arranging a monatomic or molecular gas in the interspace between the material to be drilled through or cut through and a further rear side material, which gas absorbs photons from the laser radiation and thus forms very dense plasma. In another embodiment, the interspace is filled by a solid or a highly viscous liquid.

The use of solids, in particular, for capturing the electromagnetic radiation is connected with a number of disadvantages. In order to be able to use such solids, e.g. ceramic rods or plates, the cavity between the workpiece to be cut through and a material on the rear side must be easily accessible from outside. Moreover, the solid stored therebetween is ablated and needs to be either advanced or renewed. Moreover, the ablation particles of the solid, which are detached by the electromagnetic radiation of the laser, must be easily removable from the cavity at the end of the drilling process.

When producing injection nozzles with e.g. eight separate bores it may be necessary in this case to renew the employed solid after each drilling operation. This increases the process time, decreases the automation potential and is cost intensive.

WO 2007/089469 A2 has disclosed the practice of filling the interspace with a dry, stable powder, e.g. aluminum oxide powder. Here, the size of individual particles is selected between 10 μm and 1000 μm. However, the powder must also be removed from the cavity after drilling in this solution and fresh powder may need to be replenished for the next drilling operation.

By contrast WO 00/69594 A1 and U.S. Pat. No. 6,365,891 B1 propose the use of a liquid in which dyes are present. Here, these dyes can be selected in such a way that they absorb, in particular, photons having the wavelength of the laser light. In the process, there is an electronic excitation in the dye molecules, in which electrons are lifted into higher energy levels. The photons are absorbed in this manner.

However, it is disadvantageous that such dyes fade relatively quickly and become transparent to electromagnetic radiation of the laser. Consequently, they are only suitable for short-term absorption of the electromagnetic radiation. Moreover, they generally only have a relatively small absorption cross section.

In addition to the dyes, microparticles can be contained in the liquid, said microparticles scattering the incident laser light and thus reducing the energy density of the electromagnetic radiation such that, in particular in combination with the absorption by the dye, said energy density is no longer sufficient to ablate material at undesired points.

However, in order to achieve sufficiently strong scattering of the electromagnetic radiation emitted by the laser, the particle concentration in the liquid must be very high in this case. This leads to high viscosity which prevents a high flow velocity in narrow cavities. This is disadvantageous in that, firstly, the highly viscous liquid can only be removed with difficulties again, particularly from narrow cavities, and, secondly, there is the risk at low flow velocities of the electromagnetic radiation locally evaporating the liquid and therefore there no longer being protection for materials situated therebehind in this region. Bubbles are generated, through which the laser radiation can pass through virtually unhindered.

The present invention is therefore based on the object of developing a method for laser drilling or laser cutting a workpiece in such a way that damage of materials situated behind the workpiece is prevented as reliably as possible, even in the case of small distances, with the liquid with nanoparticles simultaneously being easily removable from possibly small cavities and nevertheless being usable in the long term.

The invention achieves the stated object by a method in accordance with the preamble of claim 1, which is distinguished by virtue of the nanoparticles being embodied in such a way that the predominant portion of the electromagnetic radiation is absorbed by the nanoparticles by virtue of the electromagnetic radiation generating collective excitations in the nanoparticles.

The nanoparticles situated in the liquid must consequently be embodied in such a way that coupling of the electromagnetic laser radiation to the collective excitations is possible. In the present case, a collective excitation is understood to mean an excitation, the excitation energy of which depends on the size of the individual nanoparticles. In particular, a plurality of particles, e.g. a plurality of atoms, molecules or electrons of a nanoparticle are involved in these excitations. As a result, the collective excitation differs fundamentally from the excitations which are responsible for the absorption of electromagnetic radiation in the case of dyes. In the case of dyes and pigments, the absorption of the electromagnetic radiation is carried out by virtue of electrons within a molecule or atom being lifted to a higher energy level. The excitation energy required therefor is substantially independent of the number of molecules present because in each case only a single molecule and often even only a single electron is involved in the excitation process. A collective excitation within the meaning of the present application is different to this. In such a collective excitation, a plurality of electrons, atomic nuclei, atoms or molecules are involved. The energy required for generating such a collective excitation depends on the size of the respective nanoparticles.

The predominant portion of the electromagnetic radiation is understood to mean, in particular, more than 50%, advantageously more than 75%, particularly preferably more than 90% of the electromagnetic radiation. What is important, in particular, is that so much of the electromagnetic radiation is absorbed that the remaining portion of the radiation cannot cause any damage to the material situated in the rear space.

The method according to the invention significantly increases the quality of the bores produced by e.g. laser drilling. This relates to different aspects of the bores. A bore is a tunnel which is drilled into the material of the workpiece. Consequently, it has a front or entry side with an entry hole and a rear or exit side with an exit hole. It is often desirable for the diameter of the entry hole at the entry side and the diameter of the exit hole on the exit side to be approximately the same size. Drilling trials using a laser scanner and a picosecond laser have shown that, for example, the diameter of the exit hole on the exit side is less than half the size of the diameter of the entry hole on the entry side in the case of a bore with a length of 700 μm, corresponding to the thickness of the workpiece to be drilled through. In the trials carried out, the use of a rear space protection in accordance with the prior art with e.g. a pasty liquid could not improve the bore geometry. However, what is disadvantageous in the case of this backing is that particles of the employed rear space protection were accumulated at the workpiece to be drilled through.

However, the bore geometry is significantly improved if the nanoparticle backing described in the present invention, i.e. the liquid with the nanoparticles situated therein, is used. Trials have shown that, for example, the exit hole on the exit side is enlarged. In the case of a bore length of 700 μm, which again corresponds to the thickness of the workpiece to be drilled through, and a diameter of the entry hole of approximately 120 μm, the diameter of the exit hole lay at approximately 80 μm. Here, use was made of gold nanoparticles with a concentration of 894 mg/l. Moreover, there is an improvement in the roundness of the bore on the exit side and a smoothing of edges. Consequently, the method according to the invention surprisingly does not only ensure a particularly good rear space protection but simultaneously also achieves a significant improvement in the bore geometry.

Compared to a rear space protection from the prior art, in which microparticles which scatter occurring laser radiation and laser radiation passing through the bore and which are thus intended to reduce the energy density thereof were used, there is increased heating of the workpiece on the rear side in the case of the liquid with the nanoparticles contained therein employed here, which may be responsible for the improved bore geometry. Moreover, particles removed from the bore are removed more easily and more quickly with the liquid since the latter has a significantly lower viscosity compared to the pasty rear space protective materials from the prior art due to the relatively low concentration of nanoparticles, leading to an increased flow velocity.

In a preferred embodiment, the collective excitations are plasmons, in particular surface plasmons. Simply put, these are vibrations of the electrons in the nanoparticle caused by the electromagnetic field of the incident electromagnetic laser radiation. Such plasmons or plasmonic excitations have a significantly larger effective cross section with the incident electromagnetic radiation than is the case for individual electron excitations, as occur in dyes. Therefore, nanoparticles, in which such excitations can be generated, can be present in the liquid with a significantly lower concentration than in the case of e.g. dyes and pigments. What is achieved thereby is that the viscosity of the liquid with the nanoparticles is reduced and so high flow velocities and, in general, a good flow behavior can be achieved.

If the energy of the incident electromagnetic laser radiation now corresponds to the energy required for the generation of the collective excitation, a plasmon resonance occurs, which ensures that the nanoparticles in the liquid have an extremely low transmission. This means that a large portion of the electromagnetic radiation is absorbed by the nanoparticles, and so this radiation can cause no damage in further materials.

Advantageously, the nanoparticles have an ellipsoid form, a rod form, an octahedral form or decahedral form or a cuboid form. Here, ellipsoid forms are understood to mean all spherical forms, i.e. spherical, oval, ellipsoid forms. The excitation energy required for generating the collective excitations depends, in particular, on the spatial extents of the respective nanoparticle. It is therefore possible, particularly in the case where the spatial extents for two different spatial directions are significantly different, to excite different collective excitations in the same nanoparticles at significantly different excitation energies. This is particularly advantageous in the case where, for example, work is undertaken with two different laser wavelengths, both of which should be absorbed simultaneously by the nanoparticles.

It is also often the ratio of the spatial extents in two different spatial directions that is decisive for the excitation energy of the collective excitations. What should be mentioned in the case of rod-shaped nanoparticles is, in particular, the ratio between the longitudinal extent along the longitudinal direction of the rod and the extent in a direction perpendicular to this longitudinal extent, the so-called transverse direction. By way of example, if use is made of such rod-shaped nanoparticles made of gold, a ratio of the spatial extents between the longitudinal direction and the transverse direction of 4 leads to an excitation energy of a surface plasmon by means of which infrared laser light can be absorbed. Thus, for example, it is possible to use rod-shaped nanoparticles which have an extent of 10 nm in the longitudinal direction and an extent of 2.5 nm in a transverse direction perpendicular thereto.

Naturally, it is also possible to mix differently formed nanoparticles for an absorption that is as broadband as possible. Nanoparticles which, in principle, have the same form but different spatial extents can also be mixed in this manner and thus lead to it being possible to absorb electromagnetic radiation with very different energies and wavelengths.

These days, nanoparticles can be produced with very different forms and dimensions. As already shown, what is of decisive importance for the excitation energy of the collective excitation and hence for the wavelength of the electromagnetic radiation absorbed best in this case are, inter alia, the extents of the nanoparticles and/or the so-called aspect ratio, i.e. the ratio of length to width of a nanoparticle. At the same time, this wavelength depends on the material used. Trials have shown that the resonance of the wavelengths of the absorbed electromagnetic radiation can be shifted by changing the size of the nanoparticles. What was found in this way in the case of spherical silver nanoparticles in water is that nanoparticles with a radius of 3 nm have a resonance at 380 nm and are therefore able to absorb electromagnetic radiation of this wavelength. A radius of 10 nm leads to a resonance at 390 nm, a radius of 25 nm leads to a resonance at 410 nm, a radius of 50 nm leads to a resonance at 480 nm and a radius of 100 nm leads to a resonance at 770 nm in the case of spherical silver nanoparticles. Consequently, it is possible to identify that the position of the resonance and hence the wavelength of the absorbable laser radiation can already be clearly shifted by varying the size of the spherical silver nanoparticles.

The same applies, for example, to spherical gold nanoparticles in water. In this case, a radius of 3 nm leads to a resonance at 515 nm while an increase of the radius to 10 nm leads to a resonance at 530 nm. In this case, a further increase in the radius also leads to an increase in the wavelength of the absorbed electromagnetic radiation. A radius of 25 nm leads to an absorption at 540 nm, a radius of 50 nm leads to an absorption at 575 nm, a radius of 100 nm leads to an absorption of 770 nm and a radius of 150 nm leads to an absorption at a wavelength of 1100 nm.

If one now considers that conventional laser wavelengths for cutting and drilling lie at 800 nm, 1030 nm or 1064 nm, it is possible to find e.g. spherical gold nanoparticles in water for each of the selected wavelengths, which gold nanoparticles, due to the diameter or radius thereof, are suitable to absorb precisely the laser wavelengths radiated thereon. As an alternative thereto, the laser frequency could also be doubled and hence the wavelength of the laser radiation could be halved. Then, it would be possible to use laser wavelengths of 400 nm, 515 nm or 532 nm, which could be absorbed by e.g. very small spherical gold nanoparticles or spherical silver nanoparticles in water.

If so-called nanorods, i.e. rod-shaped nanoparticles, are used in water instead of spherical nanoparticles, it is, in particular, the aspect ratio of the nanoparticles, i.e. the ratio between length and width of the rods, that is decisive. In the case of gold, such an aspect ratio of 1 leads to an absorption at a wavelength of 530 nm. If the aspect ratio is increased to 2.5, the absorbed wavelength shifts to 700 nm; it shifts to 800 nm in the case of an aspect ratio of 4, to 850 nm in the case of an aspect ratio of 4.5 and to 900 nm in the case of an aspect ratio of 5.5. Different rod-shaped gold nanoparticles are known from the specialist article “Preparation and Growth Mechanism of Gold Nanorods Using Seed-Mediated Growth Method” from the journal Chem. Mater. 2003, 15, 1957-1962, the aspect ratios of which rod-shaped gold nanoparticles lead to resonances at 700 nm, 760 nm, 790 nm, 880 nm, 1130 nm and 1250 nm. Here, an aspect ratio of 6.5 leads to an absorption wavelength of 1000 nm, while an aspect ratio of 9 leads to an absorption wavelength of 1300 nm. In the process, the aspect ratio of the individual nanoparticles can be set very finely and accurately, and so the wavelength of the absorbed electromagnetic radiation can also be set and advantageously tuned precisely to the respective laser wavelength.

Naturally, the forms of the nanoparticles are not restricted to spherical, ellipsoid or rod forms. By way of example, different forms of rods, for example with round or rectangular cross section, or different sizes of nano-octahedrons were examined in the review article “Modeling the optical response of gold nanoparticles”, published in Chem. Soc. Rev., 2008, 37, 1792-1805. Nano-decahedrons are also producible and usable. Here too, the spatial extents and the ratio of these extents in relation to one another have a decisive influence on the wavelength of the absorbed electromagnetic radiation.

If the electromagnetic laser radiation now impinges on a nanoparticle of this type, such a photon is absorbed by the nanoparticle. In the process, it was found that the nanoparticles can fragment as a result of this laser irradiation. This fragmentation is based on the melting and evaporation as a result of the laser radiation. However, this process ends at a mean size of approximately 5 nm for e.g. gold particles, as the absorption cross section of these small nanoparticles is too small to take in an amount of energy required for further fragmenting through the laser radiation. The size at which the fragmentation of the nanoparticles by way of the laser radiation ends is referred to below as final size. To the extent that nanoparticles with this final size, i.e. nanoparticles which cannot be comminuted by further laser irradiation, exhibit collective excitations which have an excitation energy fitting to the electromagnetic laser radiation radiated thereon, it is possible, particularly in the case of spherical nanoparticles, to continue to use this liquid with the nanoparticles contained therein with virtually no wear. If the nanoparticles have a different form, for example a rod or cuboid form, this does not apply as unrestrictedly since these nanoparticles also disintegrate and fragment during the laser irradiation, with the ratio of the spatial extents in different spatial directions possibly changing.

The fragmentation of the nanoparticles occurs, in particular, in the case of irradiation with pulsed lasers. In this case, the local energy density in each pulse is so high that the nanoparticles fragment. These pulsed lasers are required to be able to process some materials of certain workpieces. In other materials, such as e.g. plastics, a lower energy density is sufficient, and so these can be processed by e.g. a cw-laser, i.e. a continuous-wave laser. In this case, the local energy density of the laser radiation is too low to lead to fragmenting in the nanoparticles. This has the great advantage that even nanoparticles that do not have a spherical embodiment do not disintegrate and fragment, and so these nanoparticles, which are tuned to the wavelength of the desired laser radiation, can also be continued to be used and used again virtually without limits. In this case, it is consequently not necessary to provide fresh nanoparticles in a new liquid in each case when processing a plurality of workpieces.

In a preferred embodiment of the method, the electromagnetic radiation has a wavelength of between 380 nm and 650 nm, preferably between 500 nm and 530 nm, more particularly 515 nm.

By selecting the size of the employed nanoparticles it is possible, as already presented above, to set the excitation energy required for generating the collective excitations. What was found for spherical gold particles in particular is that these have an excitation energy corresponding to a photon with the wavelength of 515 nm at their final size of approximately 5 nm, which consequently cannot be reduced by further laser irradiation. What is ensured if this wavelength is now used for the electromagnetic radiation source, i.e. for the laser, is that an ideal absorption cross section of the nanoparticles for the incident electromagnetic laser radiation is ensured, even in this “stationary” state, in which there is no further change in the size distribution of the nanoparticles. If other materials or other embodiments of nanoparticles are used, this final size, and hence also the “final” excitation energy, may differ from the specified numerical value. However, in general, it is advantageous to select the wavelength of the electromagnetic laser radiation radiated thereon in such a way that the selected nanoparticles have a collective excitation with an excitation energy corresponding to the energy of the photons with the wavelength radiated thereon, even in the case of long-term operation.

Consequently, use is preferably made of gold particles, particularly with a spherical form, and a laser with a wavelength of 515 nm.

In an alternative embodiment of the method, the electromagnetic radiation has a wavelength of between 950 nm and 1100 nm, preferably between 1000 nm and 1050 nm, more particularly of 1030 nm. 1030 nm in particular corresponds to one of the conventional wavelengths in laser processing, and so the method can be performed in a multiplicity of practical applications using this wavelength.

Advantageously, the liquid with the nanoparticles is used in a loop in the method described here. As a result of the fact that only a relatively low concentration of nanoparticles needs to be present in the liquid for sufficient absorption of the laser radiation radiated thereon, a sufficiently high flow velocity is ensured by the relatively low viscosity of the liquid, which may be e.g. water or acetone or a different organic solvent. The liquid with the nanoparticles contained therein is guided past the bore or cutting point of the workpiece. Subsequently, possible particles of the workpiece which become detached from the workpiece by the laser processing and which are taken up in the liquid are removed, for example by acting on said liquid with an external magnetic field or by filtration. The thus purified colloid of liquid with nanoparticles contained therein can subsequently be cooled when necessary and, once again, be guided past the bore or cutting point. The colloid used thus has a sufficient flow velocity and it can, moreover, easily be removed from narrow cavities, as are present, for example, in the production of injection nozzles or cooling bores in turbine blades.

It was found to be advantageous if a spatial extent of the nanoparticles is selected in such a way in at least one spatial direction that an excitation energy of the collective excitations corresponds to the energy of the electromagnetic radiation. The absorption cross section of the nanoparticles is optimized in this way such that a particularly large portion of the electromagnetic laser radiation can be absorbed.

Advantageously, at least some of the nanoparticles are metal particles, more particularly made of gold, silver, copper, palladium or an alloy of a plurality of the elements. Naturally, it is also possible to embody all nanoparticles in this form. By way of example, such nanoparticles can be generated directly in the fluid by laser radiation. This is a very safe production process as this prevents nanoparticles from reaching the air, which constitute a risk to the health of persons who, for example, inhale the nanoparticles. Moreover, this process is very flexible since nanoparticles can be generated in this way from many metals or alloys. At the same time, a conjugation of the nanoparticles with other substances in the liquid can occur. However, the nanoparticles can also naturally be produced in a different way and only subsequently be introduced into the liquid, e.g. water or acetone.

Advantageously, at least some of the nanoparticles consist at least in part of a chalcogenide, more particularly a copper selenide and/or a copper sulfide. It was found to be particularly advantageous if at least some, preferably all of the nanoparticles consist entirely of the chalcogenide, in particular the copper selenide or the copper sulfide.

Preferably, such nanoparticles are introduced into an organic liquid, in particular toluene. Although e.g. toluene has a relatively low boiling point and a high rate of evaporation, organic liquids, in particular toluene, have a low viscosity and hence a high fluidity. Trials have shown that this viscosity enables movement of the liquid with the nanoparticles situated therein that is sufficient to dissipate the amount of heat irradiated by the laser radiation. The non-absorbed or deflected portion of the irradiated laser radiation, the mean laser power of which having a few watt being of the order of the mean laser power to be expected in the case of laser processing, could be reduced to the one part in a thousand range. To this end, it is sufficient to move the liquid, i.e. the toluene in the present case, with the nanoparticles made of copper selenide contained therein, by stirring. As a result of the low viscosity of the toluene with the nanoparticles contained therein, it is thus not only possible to generate a sufficient amount of movement to dissipate the amount of heat introduced by the laser but it is simultaneously also possible to penetrate and rinse small and very small interspaces and hollow bodies with this combination of liquid and nanoparticles, and thus protect the respective rear space when producing a laser bore or a laser cut.

Many metals, in particular precious and semi-precious metals, can enable plasmon resonances. The excitation energies of these plasmons can be set by suitable selection of the material, the form, the size and the surrounding conditions for the nanoparticles and they can be selected virtually freely. In this way, it is possible to select the nanoparticles in a manner dependent on the laser present. Alternatively, it is naturally also possible to adapt the laser to the nanoparticles present. In any case, it is advantageous if form, size and material of the nanoparticles are tuned to the laser wavelength radiated thereon so that a plasmon resonance or the resonance of a different collective excitation emerges at the wavelength of the laser light radiated thereon.

By way of example, it is possible to use metallic spherical gold particles which, on average have a diameter of approximately 30 nm (±10 nm). This leads to a plasmon resonance at approximately 530 nm such that electromagnetic laser radiation of this wavelength can be absorbed particularly well by such nanoparticles. As already presented above, the nanoparticles are reduced in size down to a mean size of approximately 5 nm as a result of being irradiated by the laser, wherein the excitation energy of the respective plasmonic collective excitation increases slightly and corresponds to an energy which photons with a wavelength of 515 nm have. Depending on the production method, it is also possible to produce nanoparticles with a different size. Thus, for example, it is possible to use nanoparticles with a size of 100 nm to approximately 300 nm to absorb photons with longer wavelengths.

As already presented above, the use of a wavelength of 515 nm radiated thereon is advantageous, particularly in the case of gold particles as this corresponds to the plasmon resonance of gold particles with a 5 nm diameter. Nanoparticles of this size are not comminuted any further by laser irradiation, and so such a gold-nanoparticle suspension can be used for a virtually unlimited period of time as a rear space protection and as absorption material for laser radiation, without the shielding effect being reduced or even lost.

Advantageously, at least some of the nanoparticles are arranged on a surface of microparticles. Naturally, it is also possible to arrange all nanoparticles on the surface of microparticles. The use of microparticles in liquids as rear space protection in laser drilling and laser cutting methods is known from the prior art. However, the laser radiation is not absorbed as a result of collective excitations of the microparticles, but is scattered, as a result of which the energy density of the laser radiation is reduced. In this manner, it is also possible to prevent the laser radiation, after it has penetrated the workpiece, from causing damage in other materials which, in particular, are situated in the rear space of the workpiece. As already presented above, effective rear space protection can hardly be achieved by this effect only since the effective cross section of the scattering at the microparticles is relatively low and hence the required concentration of microparticles is very high. However, if nanoparticles, as described in the present case, are adsorbed at the surface of the microparticles, the different effects caused by the microparticles and the nanoparticles are combined. Thus, there is both absorption of the electromagnetic laser radiation by the nanoparticles and scattering of the radiation by the microparticles, on the surface of which the nanoparticles are adsorbed.

In an advantageous embodiment of the method, at least some of the nanoparticles are carbon nanotubes. Naturally, it is also possible for all nanoparticles to be embodied as carbon nanotubes. Collective excitations can also be caused in such carbon nanotubes. The nanotubes can be produced with a virtually freely adjustable length, wall thickness and diameter such that the excitation energy required for generating the collective excitations can be set virtually freely in this case as well. In this case, said excitation energy can also be set in an ideal manner in relation to the laser wavelength radiated thereon. In relation to e.g. metal particles, carbon nanotubes have the additional advantage that they are available as a black powder and hence, in addition to the high absorption cross section by collective excitations, additionally have a relatively high absorption cross section by electronic excitations. Hence, they unify the advantages of dyes with the advantages of nanoparticles with collective excitations.

Advantageously, at least some of the nanoparticles have a photosensitive substance on a surface thereof. Naturally, it is also possible for all nanoparticles to be provided with such a photon-sensitive substance on the surface thereof. Photosensitive substances are dyes or pigments that are suitable for absorbing electromagnetic radiation with specific wavelengths. If these dyes are arranged on a surface of the nanoparticles, they consequently amplify the absorption cross section of the nanoparticles provided thus since now, like in the case of the carbon nanotubes already described above, the effects of collective excitations of the nanoparticles are combined with the electronic excitations of the photosensitive substances.

It was found to be advantageous if the liquid contains nanoparticles with a concentration of less than 4 g/l, preferably less than 2 g/l, particularly preferably less than 1 g/l. However, the actual employed concentration depends on a multiplicity of different parameters and it can be selected depending on the desired problem and property of the trial or production setup. The actual concentration in this case depends, inter alia, on the intensity of the laser radiation radiated thereon and the wavelength of the laser radiation compared with the excitation energy of the collective excitations. The amount of space in the rear space of the workpiece to be treated also plays an important role. As the distance to the rear space material to be protected becomes smaller, the concentration of the nanoparticles needs to be selected to be higher in order to be able to ensure that a sufficient amount of the laser radiation radiated thereon can be absorbed. Alternatively or additionally, it is also possible to increase the flow velocity of the liquid.

In this case, the employed liquid only plays a subordinate role for as long as the employed nanoparticles are stable within this liquid.

Experimentally, the absorption of gold nanoparticles in water was determined at a laser wavelength of 515 nm within the scope of an example. The gold nanoparticles were filled with a concentration of 3.6 g/1 into a quartz glass cuvette with a layer thickness of 2 mm.

The latter was introduced into slightly divergent beam path of a picosecond laser, wherein the cuvette was situated 50 mm below the laser focus. No transmitted radiation could be measured by a thermal measuring head in the case of an input power of 3.5 W. No bubbles, through which the radiation could have passed through, formed in the cuvette, even after an irradiation time of 10 s.

In order to enable a better comparison of different materials, the thermal measuring head was replaced by a photodiode. The displayed pulse peak voltage of the photodiode was on average 51 mV in the case of the above-described gold-nanoparticle suspension. There was only a single peak with a height of 96 mV within the measurement duration of 10 seconds. In contrast thereto, a measurement signal of 1.76 V could be measured e.g. in the case of a conventional pasty liquid which is used for rear space protection trials in accordance with the prior art. Consequently, the gold-nanoparticle suspension achieved an attenuation that was at least 18 times stronger.

In a second trial, the cuvette position was modified to a distance 30 mm below the focus of the laser. The transmission of the laser radiation through the gold-nanoparticle suspension resulted in 75 mV, whereas the transmission of the laser radiation in a pasty liquid in accordance with the prior art reached 4.08 V.

The present invention is explained in more detail below with the aid of two figures. In detail:

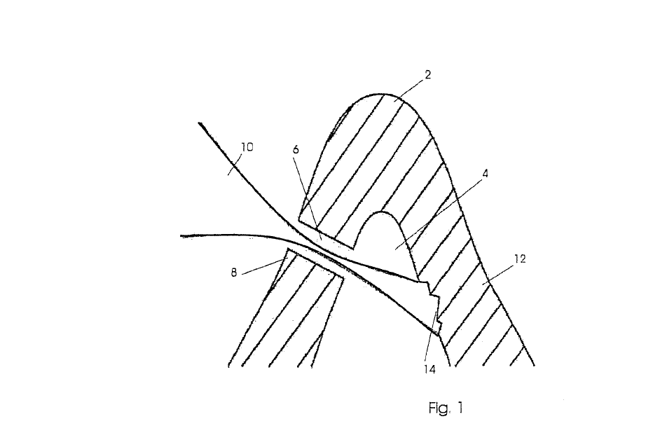

FIG. 1 shows the schematic illustration of rear wall damage during laser drilling and

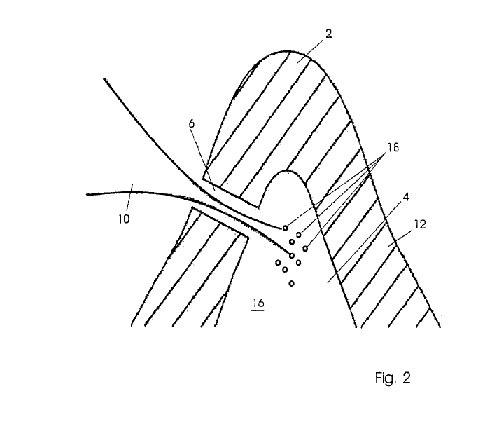

FIG. 2 shows the schematic illustration using a method in accordance with a first exemplary embodiment of the present invention.

FIG. 1 shows a workpiece 2 with a cavity 4 situated in the interior thereof. A through-bore 6 should be drilled into the workpiece 2, for the purposes of which a front side 8 of the workpiece 2 is irradiated with laser radiation 10.

In the stage of the method shown in FIG. 1, the through-bore 6 has already been opened, and so the laser radiation 10 penetrates the workpiece 2. In so doing, the laser radiation impinges on a rear space material 12 in the rear space and leads to damage 14 there. It is the object to prevent this using a method in accordance with an exemplary embodiment of the present invention.

In FIG. 2, a through-bore 6 should once again be introduced into the workpiece 2, for the purposes of which use is once again made of laser radiation 10. However, a liquid 16, in which nanoparticles 18, which are indicated schematically as circles, are situated, is now situated in the cavity 4. The laser radiation 10 impinges on the nanoparticles 18 and causes a generation of a collective excitation here such that the laser radiation 10 is absorbed by the nanoparticles 18. It is possible to see that the rear space material 12 remains undamaged.

While the laser radiation 10 introduces the through-bore 6 into the workpiece 2, particles of the material of the workpiece 2 are detached and mixed with the liquid 16. The liquid 16 with the nanoparticles 18 contained therein is guided past the through-bore 6 and cleansed of the particles made of the material of the workpiece 2 in further method steps (not depicted here). By way of example, this can be carried out by way of filtration or by way of magnetic fields. Subsequently, the liquid 16 with the nanoparticles 18 is cooled and fed again to the position shown in FIG. 2.

### LIST OF REFERENCE SIGNS

2 Workpiece

4 Cavity

6 Through-bore

8 Front side

10 Laser radiation

12 Rear space material

14 Damage

16 Liquid

18 Nanoparticles

1. A method for laser drilling or laser cutting a workpiece, wherein
electromagnetic radiation emitted by a laser impinges on the workpiece and
a liquid containing nanoparticles is situated on a side of the workpiece facing away from the laser
such that electromagnetic radiation emitted by the laser impinges on the nanoparticles once the electromagnetic radiation has passed through the workpiece,
wherein the nanoparticles are embodied in such a way that a predominant portion of the electromagnetic radiation is absorbed by the nanoparticles by virtue of the electromagnetic radiation generating collective excitations in the nanoparticles.

2. The method as claimed in claim 1, wherein a size and/or a form of the nanoparticles is adapted to the electromagnetic radiation for the purposes of generating the collective excitations.

3. The method as claimed in claim 1, wherein the nanoparticles have an ellipsoid form, a rod form, an octahedral form or decahedral form, or a cuboid form.

4. The method as claimed in claim 1, wherein the electromagnetic radiation has a wavelength of between 380 nm and 650 nm.

5. The method as claimed in claim 1, the electromagnetic radiation has a wavelength of between 950 nm and 1100 nm.

6. The method as claimed in claim 1 wherein a spatial extent of the nanoparticles is such that in at least one spatial direction an excitation energy of the collective excitations corresponds to energy of the electromagnetic radiation.

7. The method as claimed in claim 1, wherein at least some of the nanoparticles are metal particles.

8. The method as claimed in claim 1 wherein at least some of the nanoparticles consist at least in part of a chalcogenide.

9. The method as claimed in claim 1 wherein at least some of the nanoparticles are arranged on a surface of one or more microparticles.

10. The method as claimed in claim 1, wherein at least some of the nanoparticles are carbon nanotubes.

11. The method as claimed in claim 1 wherein at least some of the nanoparticles have a photosensitive substance on a surface thereof.

12. The method as claimed in claim 1 wherein the liquid contains nanoparticles with a concentration of less than 4 g/l.

13. The method of claim 1 wherein said collective excitations are plasmons.

14. The method of claim 13 wherein said plasmons are surface plasmons.

15. The method as claimed in claim 1, wherein the electromagnetic radiation has a wavelength of between 500 nm and 530 nm.

16. The method as claimed in claim 1 wherein the electromagnetic radiation has a wavelength of 515 nm.

17. The method as claimed in claim 1, wherein the electromagnetic radiation has a wavelength of between 1000 nm and 1050 nm.

18. The method as claimed in claim 1 wherein the electromagnetic radiation has a wavelength of 1030 nm.

19. The method as claimed in claim 7 wherein the metal particles ae selected from the group consisting of gold, silver, copper, palladium, and an alloy of a plurality of these elements.

20. The method as claimed in claim 8 wherein said chalcogenide is selected from the group consisting of a copper selenide and a copper sulfide.
